(19) United States
(12) Patent Application Publication
(10) Pub. No.: US 2025/0252488 A1
(43) Pub. Date: Aug. 7, 2025

(54) SYSTEMS AND METHODS FOR USE IN MANAGING NETWORK TRAFFIC

(71) Applicant: MASTERCARD INTERNATIONAL INCORPORATED, PURCHASE, NY (US)

(72) Inventors: Prateek Khamesra, White Plains, NY (US); Biju Oommen, Macquarie Park (AU); Jeanne B. Moore, Webster Groves, MO (US); Lukas Ekselius, Overijse (BE); Megan Simons, Auckland (NZ); Mohit Bijlani, Fort Lee, NJ (US); Natalie Hung, Sans Souci (AU); Surin Fernando, Lilyfield (AU)

(21) Appl. No.: 18/433,301

(22) Filed: Feb. 5, 2024

(51) Int. Cl. G06Q 20/38; G06Q 20/10; G06Q 20/36

(52) U.S. Cl. CPC G06Q 20/3821; G06Q 20/105; G06Q 20/3674

(57) ABSTRACT

Systems and methods are provided for managing network traffic. One example method includes receiving an authorization message for a network transaction, the authorization message including a merchant ID (MID), an interbank card association (ICA) number, and a primary account number (PAN) for an account of a user; determining, by the installment host computing device, whether the MID and ICA are registered for installments; in response to determining that the MID and ICA are registered for installments: determining whether the PAN is an installment PAN; and in response to determining that the PAN is the installment PAN: determining a resource code based on the authorization message; appending the resource code to the authorization message; and forwarding the authorization message including the resource code to an issuer of the account.

### FIELD

The present disclosure generally relates to systems and methods for use in managing network traffic.

### BACKGROUND

This section provides background information related to the present disclosure which is not necessarily prior art.

Parties are known to offer various different products to users, and users are known to purchase such products. Purchases are sometimes funded through payment accounts, such as credit accounts, debit accounts, prepaid accounts, etc., where the users present payment devices to the parties to initiate transactions for the products. The transactions are immediately authorized, and then later settled and cleared among associated banks. Other forms of payment for products may include cash, checks, gift cards, etc., or also, loan options or installment options provided by the parties or other parties.

### BRIEF DESCIPTION OF DRAWINGS

The drawings described herein are for illustrative purposes only of selected embodiments and not all possible implementations, and are not intended to limit the scope of the present disclosure.

FIG. 1 illustrates an example system of the present disclosure suitable for use in managing network traffic;

FIG. 2 is a block diagram of an example computing device that may be used in the system of FIG. 1; and

FIG. 3 is an example method that may be implemented in connection with the system of FIG. 1 for use in managing network traffic.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Users may purchase products from parties (e.g., first parties, etc.). In connection therewith, it may not be possible, or desirable, for the users, for example, to fully pay funds for the products to the parties at the time of the purchases, whereby the users may instead pay the funds over time through installments, also known as buy-now-pay-later (BNPL). In such instances, the installment options are integrated with the parties, either at virtual locations of the parties, or at physical point of sale (POS) devices at the parties. However, this integration is often inefficient and problematic, as the technical implementation is often beyond the capabilities of the parties.

Uniquely, the systems and methods herein permit users to initiate installment options, through network traffic, whereby the installment options are implemented by and between the associated parties and the users, through the network traffic. In particular, certain data included in the authorization messaging associated with the network traffic is used to invoke installments, including, for example, an identifier associated with a first party (e.g., MID, etc.), an identifier associated with a registered acquirer (e.g., ICA, etc.) and an account number of the user. When invoked, the messaging is adapted to include a resource code indicating of terms of the installment options. The terms are then imposed during clearing of the transactions, whereby installments are imposed within the settlement of the transactions with the involved parties. In this manner, limited integration, if any, is required at the parties offering the products for sale or at other parties and associated institutions (e.g., acquirers, etc.), to implement installment programs for the installment options and to address the technical problems and limitations associated therewith.

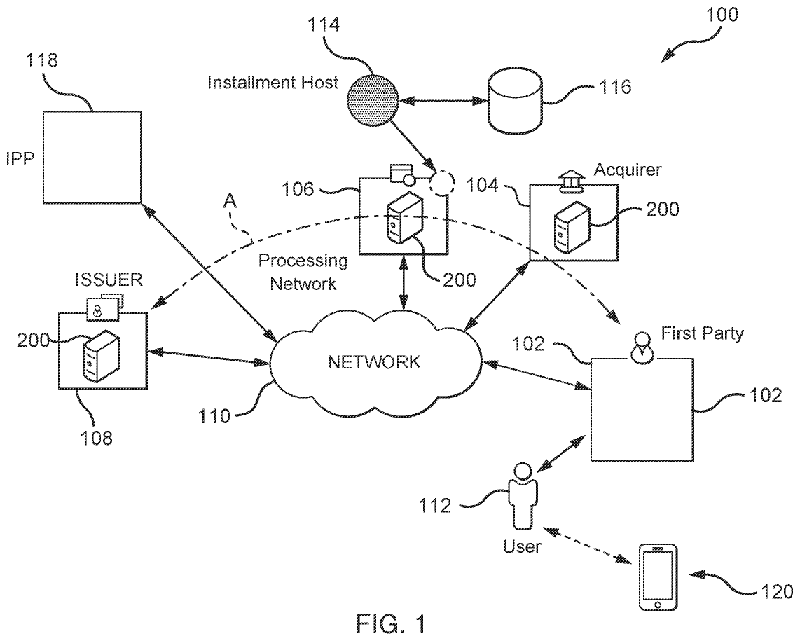

FIG. 1 illustrates an example system 100 in which one or more aspects of the present disclosure may be implemented. Although the system 100 is presented in one arrangement, other embodiments may include systems arranged otherwise depending, for example, on processing of payment account transactions, delivery of transaction data, manners in which payment account transactions are initiated, privacy concerns, etc.

In the illustrated embodiment, the system 100 generally includes a first party 102, an acquirer 104, a processing network 106, and an issuer 108, each coupled to (and in communication with) a network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the processing network 106 to the acquirer 104 and the issuer 108 and, separately, the public Internet, which is accessible as desired to the first party 102, the processing network 106, the issuer 108, and one or more various users in the system 100 (e.g., user 112, etc.), etc.

The first party 102 in the system 100 is generally a merchant associated with offering products (e.g., goods and/or services, etc.) for purchase to one or more users (including user 112). The first party 102 may offer the products for sale through a physical storefront and/or a virtual storefront, etc., for example, to the user 112. The products may be of a type, whereby the users may seek to purchase the products through installment payments, rather than a lump sum payment at the time of purchase. Such products may include any products, and generally, are agnostic as far as pricing, for example.

In this example embodiment, the acquirer 104 is a financial institution, such as, for example, a bank. The acquirer 104 is configured to issue an account to the first party 102. The account may be a payment account, or checking account, or other type of bank account into which the first party 102 is permitted to received funds.

Similarly, in this example embodiment, the issuer 108 is a financial institution, such as, for example, a bank. The issuer 108 is configured to issue an account to the user 112. The account may be a payment account or other type of bank account from which the user 112 is permitted to pay funds. Further, in this example, the account of the user 112 is associated with a primary account number or PAN. The PAN may be, for example, embossed on a front/back of a payment card, or encoded into the payment card, or provisioned to an electronic/virtual wallet associated with the user 112. In this way, the user 112 is permitted to present the account for payment and to identify the account via the PAN (or token associated with the PAN). The PAN is therefore referred to as the installment PAN. In addition to identifying the account, the PAN is also, in this example, specific to installment payment options. In one or more examples, the account may be associated with a BAU PAN, or “business-as-usual” PAN, which is described in more detail below.

The user 112 is also associated with a communication device 120. The communication device 120 may include a smartphone, a tablet, a personal computer, a laptop, a desktop, a workstation, a PDA, etc., which is coupled to and/or is in communication with the issuer 108 (e.g., via an application associated with the issuer 108, via a web browser, or otherwise, etc.), for example, via the network 110.

As it relates to installments, the system 100 includes an installment host 114 and a ledger data structure 116. The installment host 114 is coupled to (and is in communication with) the ledger data structure 116, and is specifically configured, by executable instructions, to perform one or more of the operations herein. In connection therewith, the installment host 114 and the ledger data structure 116 may each be considered a computing device consistent with computing device 200 described hereinafter. While the installment host 114 and the ledger data structure 116 are illustrated as separate parts of the system 100 in FIG. 1, one or both may be incorporated into and/or located at one or more other parts of the system 100 (e.g., at the processing network 106 as indicated by the arrow in FIG. 1, at the issuer 108, etc.). In addition, while the ledger data structure 116 is illustrated as separate from the installment host 114 in the system 100, in other embodiments the ledger data structure 116 may be included, or integrated, in the installment host 114, for example, in memory 204 therein.

In connection therewith, merchants and acquirers may be registered with the installment host 114 to enable installment payments at the respective first parties, and also the issuers may be registered with the installment host 114 to enables installment payments for accounts issued by the issuer. In the system 100, each of the first party 102, the acquirer 104, and the issuer 108 is registered with the installment host 114. As a result, a specific merchant ID is included in the ledger data structure 116, which lists the registered first parties (including the first party 102). And, the acquirer Interbank card association (ICA) number, for the acquirer 104, is included in the ledger data structure 116, as well as a range of PAN, which are designated by the issuer 108 as installment PANs.

It should be appreciated that the issuer 108 has issued an account associated with a PAN, which is within the PAN range, to the user 112, whereby the user 112 is also considered registered for installment purchases through one or more registered first parties. In connection with issuance of the account, the issuer 108 may be configured to inform the user 112 of the terms associated with installments, for example, as indicated in Table 1 or Table 2 below. The account for the installment purchase may be a specific product category for the issuer 108, such as, for example, Silver Installment by First Party, Platinum Installment by First Party, etc., where different products may be assigned different PAN ranges, may be available to different users, and/or may carry different term(s) (e.g., depending on the quality of qualifications of the users, etc.). Further, it should be appreciated that the user 112 often designates a repayment account (e.g., also issued by the issuer 108 or issued by another financial institution, etc.) to be used for installment repayment, as indicated more below.

As further shown in FIG. 1, the system 100 includes an installment payment provider (IPP) 118, which, in this embodiment, is separate from the acquirer 104, the processing network 106, the issuer 108, and the installment host 114, etc. The IPP 124 is configured, in general, to manage underwriting of installment plans herein (e.g., as provided in connection with the issuer 108, etc.) and to interact with the user 112 (and other users) in connection therewith (e.g., upon selection of one of such plans by the user 112 (and other users), etc.). That is, for example, the IPP 118 may be configured to indicate terms of installments to the user 112, forecast installment payments being due, and facilitate payment of the installments, etc.

Given the above, in one example transaction with the first party 102, the user 112 contacts the first party 102, or physically is present at the first party 102, to present credentials for the user's payment account. When the user 112 decides to pay by installment, the user 112 presents the installment PAN as the credential to the first party 102, through swiping, tapping, etc., a payment card (or the communication device 120, when provisioned with the installment PAN), whereby the installment PAN is delivered to the first party 102. Thereafter, the first party 102 (or specifically, a point of sale (POS) terminal of the first party 102, etc.) is configured to capture the installment PAN and to generate an authorization message (i.e., authorization request in this instance) for the transaction to be funded by the user's payment account and communicates the authorization message to the acquirer 104 (along path A in FIG. 1). The authorization message includes various details of the transaction, such as, for example, the amount, the installment PAN, merchant category code (MCC), etc. Specifically, a merchant ID or MID specific to the first party 102 and an ICA specific to the acquirer 104 are included as part of the authorization message.

In turn, the acquirer 104 communicates the authorization request, along path A, generally to the processing network 106, such as, for example, through the MASTERCARD, VISA, or DISCOVER processing network, etc.

Upon receipt at the processing network 106, the installment host 114 is configured to determine whether the MID, ICA and PAN are included in the ledger data structure 116. In particular, the installment host 114 is configured to identify the ICA from the authorization message (e.g., located at a specific data element (DE), etc.) and to search in the ledger data structure 116 for the ICA. When the ICA is included therein, the installment host 114 is configured to proceed to identify the MID from the authorization message (e.g., located at a specific data element (DE), etc.) and to search in the ledger data structure 116 for the MID. When the MID is included therein, the installment host 114 is configured to proceed to identify the PAN from the authorization message (e.g., located at a specific data element (DE), etc.) and to search in the ledger data structure 116 for the PAN. When the PAN is included among the installment PANS, for example, based on a bank identification number (BIN) range included in the ledger data structure 116, the installment host 114 is configured to proceed to identify the transaction as an installment transaction.

It should be appreciated that the installment host 114 may be configured to search for the ICA, MID and PAN in different orders, or at the same time or otherwise, to confirm the installment transaction.

Next, the installment host 114 is configured to identify the correct resource code. The resource code is identified, for example, based on the amount of the transaction or other criteria of the transaction.

Table 1 illustrates an example in which amount ranges are associated with different resource codes, which, in turn, are associated with different terms, including a tenure in months (e.g., each payment per month, whereby pay in nine (9) includes nine monthly payments, etc.) and the associated rate for the installment in basis points (bps), etc.

TABLE 1

| | | Resource | | |
|---|---|---|---|---|
| Tier | Tenure | Code | Rate | |
| 0-$100.00 | Pay in 1 | 111111 | 80 | bps |
| $100.01-$300.00 | Pay in 4 | 222222 | 100 | bps |
| $300.01-$500.01 | Pay in 6 | 333333 | 110 | bps |
| $500.01-$1,000.00 | Pay in 9 | 444444 | 120 | bps |
| $1,000.01-$1,500.00 | Pay in 12 | 555555 | 150 | bps |
| $1,500.01 or more | Pay in 18 | 666666 | 180 | bps |

Table 2 illustrates another example in which amount ranges are associated with different resource codes, which, in turn, are associated with terms, including a tenure in months (e.g., each payment per month, whereby pay in nine (9) includes nine monthly payments, etc.), multiple different merchant categories, and the associated rate for each merchant category of the installment in basis points (bps), etc. As such, from Table 2 it may be seen that other criteria (e.g., merchant categories, etc.) may be used (e.g., alone or in combination with transaction amount, etc.) to determine rates for payment options. Thus, as shown, different criteria/parameters may be used to set qualifications and terms for payment options. In further examples, the different merchant categories may be used as the basis for determining rates, independent of transaction amount. Here, one merchant category may be a pay in 1 while others may be associated with different installments, regardless of transaction amount (or, potentially, subject to different transaction amounts). It should be appreciated that other combinations of criteria may be used in other examples.

TABLE 2

| | | | | | | Standard |
|---|---|---|---|---|---|---|
| | | Resource Code and Rate | | | | Non- |
| Tier | Tenure | Category 1 | Category 2 | Category 3 | Category 4 | Participant |
| 0- | Pay in 1 | 18 bps | 20 bps | 23 bps | 50 bps | 50 bps |
| $100.00 | | (111111) | (222222) | (333333) | (444444) | |
| $100.01- | Pay in 3 | 50 bps | 90 bps | 120 bps | 150 bps | 50 bps |
| $1000.00 | | (111111) | (222222) | (333333) | (444444) | |
| $1000.01- | Pay in 6 | 80 bps | 120 bps | 170 bps | 200 bps | 50 bps |
| $2000.00 | | (111111) | (222222) | (333333) | (444444) | |
| $2000.01- | Pay in 9 | 120 bps | 170 bps | 220 bps | 250 bps | 50 bps |
| $3,000.00 | | (111111) | (222222) | (333333) | (444444) | |
| $3000.01 | Pay in 12 | 150 bps | 200 bps | 250 bps | 300 bps | 50 bps |
| or more | | (111111) | (222222) | (333333) | (444444) | |

It should be appreciated that other resource codes may be included and/or that the resource codes may be based on other criteria included in the authorization message. For example, the resource codes may be specific to the first party 102, where the different terms may be associated with different first parties (e.g., based on the MID, etc.). In another example, the terms may be specific to different MCCs, whereby different categories of merchants or products may indicate different terms (e.g., higher interest for luxury items, etc.). The terms may further be different based on location of the first party (or user 112), time of year/week/day, issuer of the installment PAN (e.g., brand competition for better terms, etc.), etc.

It should be further appreciated that additional interchange fees may be applied to the transaction for one or more other reasons, for the benefit of the first party 102, the acquirer 104, the processing network 106, the issuer 108, etc.

In this example embodiment, the installment host 114 is configured to append the source code to the authorization message (e.g., at data element (DE) 48, sub-element (SE) 32, etc.) and, generally, the processing network 106 is configured to transmit the message to issuer 108. The issuer 108 is configured to approve or decline the transaction based on, for example, criteria associated with the user 112. In general, as the user 112 is previously registered (and/or approved) for installments, as the account for installments is issued to the user 112, the issuer 108 is generally configured to provide an approval (e.g., based on the prior risk analysis performed y the issuer 108, etc.). That said, based on the authorization request, the issuer 108 may be configured to decline the transaction for one or more reasons (e.g., MCC, amount, etc.). In addition, the issuer 108 is also configured, optionally, to store the resource code in connection with the authorization message.

In connection therewith, the issuer 108 is configured to compile an authorization message (i.e., an authorization reply in this instance) and to transmit the authorization message to the acquirer 104, via the processing network 106. The acquirer 104 is configured, in turn, to store the authorization message (including the resource code) and to transmit the authorization message back to the first party 102.

At this point, the first party 102 is configured to deliver the purchased product to the user 112, whether in person or through shipment of the product to the user 112. The user 112 is then responsible to make payment consistent with the installment assigned to the transaction.

At one or more intervals, the processing network 106 is configured to coordinate clearing and settlement between the acquirer 104 and the issuer 108 (and potentially, an installment payment provider (IPP) such as IPP 118). As part thereof, the acquirer 104 is configured to submit a clearing file, which includes the installment transaction. The clearing file includes information from the authorization message, including, specifically the resource code.

In response to the clearing file, the processing network 106 is configured to retrieve the resource code from the authorization information for the installment transaction and to identify the terms associated with the respective code. The processing network 106 is further configured to calculate the appropriate charge for the installment transaction, which includes the amount of the transaction multiplied by the rate associated with the research code. For example, for an installment transaction in the amount of $420, the associated rate is 110 bps, whereby $420 is multiplied by 0.011 to yield a charge of $4.62. The charges added to the installment transaction clearing.

In this example embodiment, as part of clearing, the processing network 106 is configured to credit the acquirer 104 for the amount of the transaction, to debit the transaction and the charge from the issuer 108 (to be attributed to the user 112), and to credit the issuer 108 for the charge. In another example embodiment, where the installment is supported by the IPP 118, the processing network 106 is configured, potentially, to credit the charge to the IPP 118 or to split the charge between the IPP 118 and the issuer 108, etc. It should be appreciated that where the first party 102 opts to charge a fee for the installment (e.g., for offering the integrated convenience funding option to users, etc.), the appropriate fee (and/or division of fees) would be part of the associated terms of the installment (e.g., and included in Table 1) and then charged appropriately in a clearing process (e.g., as a batch file or via an API, etc.) and paid to the first party 102, through the acquirer 104.

It should be appreciated that other interchange fees associated with the transaction may be split between the acquirer 104, the processing network 106, and/or the issuer 108, as appropriate.

Thereafter, the processing network 106 is configured to settle the installment transaction, including the charge(s), by imposing the appropriate credits and debits to the accounts of the acquirer 104, the issuer 108, and/or the IPP 118. Next, the issuer 108 and/or IPP 118 (optionally) are configured to record the installment terms in connection with the purchase and to initiate pull payments consistent with the terms of the installments. The payments may be initiated to pull funds from a repayment account designed by the user 112 to fulfill the installment terms (e.g., upon registration by the user 112 for the installment payment/option, etc.). In this way, the acquirer 104 and issuer 108 (and the IPP 118) are each configured to participate in one settlement for the transaction, which is generally consistent, for the acquirer 104, to other transaction (i.e., non-installment transactions) whereby the impact on the acquirer 104 is limited while offering expended payment options to the first party 102.

While one first party 102, one acquirer 104, one processing network 106, one issuer 108, one user 112, and one communication device 120 are included in the system 100 illustrated in FIG. 1, it should be appreciated that any number of these entities, devices, and/or persons (and their associated components) may be included in the system 100, or may be included as a part of systems in other embodiments, consistent with the present disclosure.

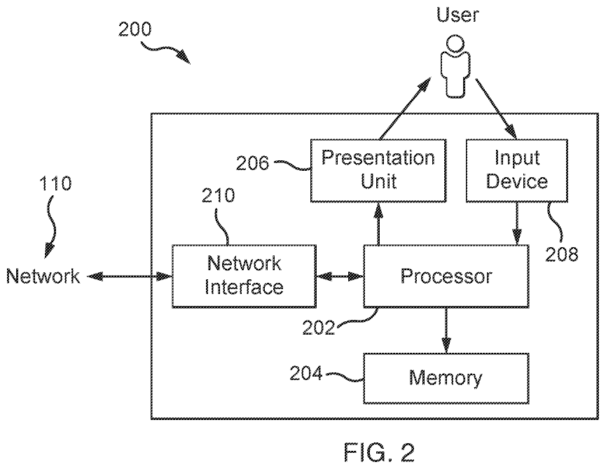

FIG. 2 illustrates an example computing device 200 that can be used in the system 100. The computing device 200 may include, for example, one or more servers, workstations, personal computers, laptops, tablets, smartphones, PDAs, POS devices, etc. In addition, the computing device 200 may include a single computing device, or it may include multiple computing devices located in close proximity or distributed over a geographic region, so long as the computing devices are specifically configured to function as described herein. In particular, in the example system 100 of FIG. 1, each of the acquirer 104, the processing network 106, and the issuer 108 are illustrated as including, or being implemented in, computing device 200, coupled to the network 110. In addition, the user's communication device 120 may be considered a computing device consistent with computing device 200. What's more, the first party 102, the installment host, data structure 116, and the IPP 118 may include and/or be implemented in at least one computing device consistent with the computing device 200. That said, however, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, data relating to installment transactions, charges, resource codes and associated terms and criteria, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein whereby, in connection with such performance, the computing device 200 may be transformed into a special-purpose computing device for managing network traffic. It should be appreciated that the memory 204 may include a variety of different memories, each implemented in one or more of the functions or processes described herein.

In addition in the example embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., confirmation of installment details, etc.), either visually or audibly, to a user of the computing device 200, for example, the user 112, users associated with other parts of the system 100, etc. Various interfaces (e.g., as defined by network-based applications, webpages, short message service (SMS) messages, emails, etc.) may also be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

The computing device 200 also includes an input device 208 that receives inputs from the user of the computing device 200 (i.e., user inputs) such as, for example, reading account numbers, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), a mobile network adapter, or other device capable of communicating to/with one or more different networks, including the network 110. Further, in some example embodiments, the computing device 200 may include the processor 202 and one or more network interfaces (including the network interface 210) incorporated into or with the processor 202.

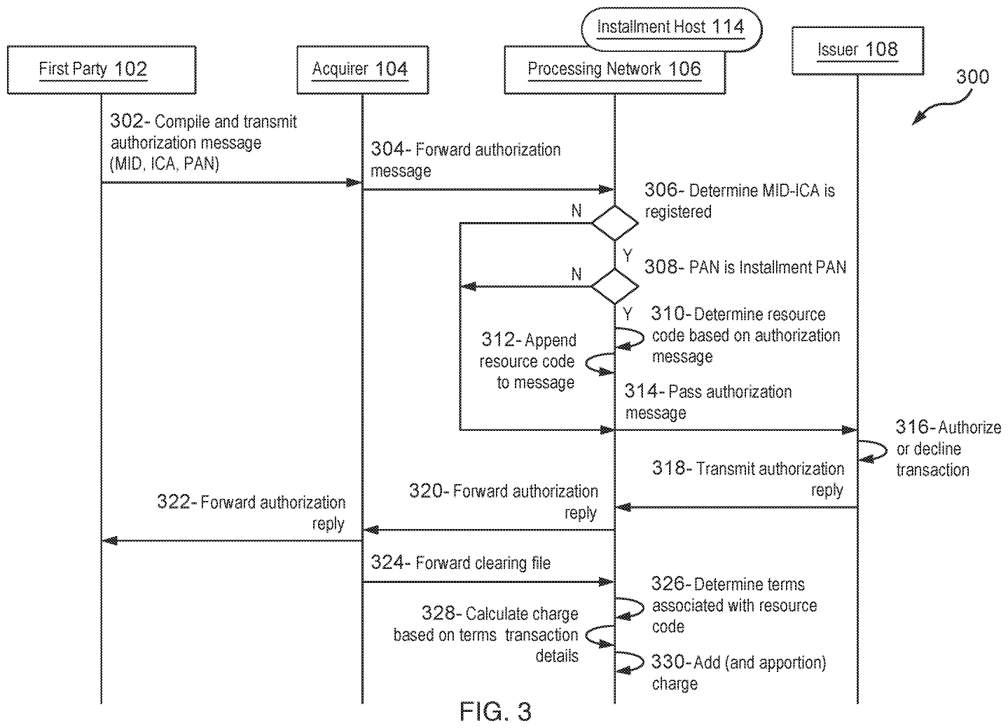

FIG. 3 illustrates an example method 300 for use in managing network traffic. The example method 300 is described as implemented in the system 100 with reference made to the installment host 114 and the ledger data structure 116, and further with reference to computing device 200. However, it should be understood that the method 300 is not limited to this configuration of the system 100, as the method 300 may be implemented, at least in part, in other parts of the system 100, or in multiple other computing devices or systems. As such, the methods herein should not be understood to be limited to the example system 100 or the example computing device 200, and likewise, the systems and the computing devices herein should not be understood to be limited to the example method 300.

At the outset in the method 300, it should be appreciated that the acquirer 104 and the first party 102 are registered with the installment host 114. As such, the ICA for the acquirer 104 is included in a registered listing in the data structure 116, and the MID for the first party 102 is included in the registered listing in the data structure 116.

In connection with a transaction of the user 112 at the first party 102, the user 112 provides payment credentials to the first party 102, where the payment credentials include an account number or PAN of an account of the user 112 issued by the issuer 108. In turn, at 302, the first party 102 compiles an authorization message for the transaction and transmits the authorization message to the acquirer 104. The authorization message for the transaction includes, without limitation, the amount of the transaction, the MID for the first party 102, the ICA for the acquirer 104, the MCC for the first party 102, and other information related to the transaction.

In response to the authorization message, at 304, the acquirer 104 forwards the authorization message to the processing network 106.

Upon receipt of the authorization message, the installment host 114 (as part of the processing network 106 in this example) determines, at 306, whether the MID-ICA are included in the data structure 116, i.e., whether the acquirer 104 and the first party 102 are registered for installments. In connection therewith, the installment host 114 searches for the MID and then the ICA in the data structure 116. When the MID-ICA are included in the data structure 116, the installment host 114 determines, at 308, whether the PAN included in the authorization message is an installment PAN. Specifically, each PAN includes a BIN, which is part of a BIN range. Installment PANs are associated with a particular BIN range for the issuer 108. As such, the installment host 114 determines whether the PAN included in the authorization message includes a BIN within the BIN range for the issuer 108 for installment accounts.

When the PAN is an installment PAN, the installment host 114 determines a resource code for the transaction, at 310. The resource code is generally determined based on information included in the authorization message. For example, as explained above, the installment host 114 may determine the resource code based on the amount of the transaction relative to Table 1. In other examples, other data included in the authorization message may additionally or alternatively indicate the particular resource code for the transaction.

At 312, the installment host 114 appends the resource code to the authorization message. In this example embodiment, the installment host 114 appends the resource code to DE48, SE 32, which is defined by the International Standards Organization (ISO) 8583 standard for financial messaging. Thereafter, at 314, the installment host 114 passes the authorization message, with the resource code, to the issuer 108.

Conversely, as illustrated in FIG. 3, when the MID-ICA are not registered, or the PAN is not an installment PAN, the method 300 proceeds directly to step 314 and the transaction is processed/proceeds as is conventional.

In either case, at 316, the issuer 108 then decides whether to authorize or decline the transaction, generally, based on the data included in the authorization message. In turn, the issuer 108 compiles an authorization reply indicating either the authorization or decline of the transaction and transmits, at 318, the authorization reply to the processing network 106. The processing network 106 then forwards the authorization reply, at 320, to the acquirer 104, which, in turn, then forwards the authorization reply, at 322, to the first party 102. The acquirer 104 further stores in memory (e.g., the memory 204, etc.) the authorization message/reply.

Thereafter, at one or more clearing intervals (e.g., once per day, once per N hours, etc.), the acquirer 104 compiles and forwards, at 324, a clearing file for the interval. In this example the clearing file is representative of the authorized installment transaction described above. As such, the clearing file includes the information included in the authorization message/reply including, specifically, the amount of the transaction and the resource code.

In response to the clearing file from the acquirer 104 and other acquirers (e.g., the issuer 108 for other transactions, etc.), the processing network 106 identifies the resource code in the clearing file for the transaction and determines, at 326, the terms associated with the resource code. The processing network 106 then calculates, at 328, the charge for the installment transaction based on the terms and the transaction details included in the clearing file. Specifically, for example, the processing network 106 multiplies the rate associated with the resource code by the amount of the transaction, which is the charge for the installment transaction.

At 330, the processing network 106 adds the charge to the transaction. It should be appreciated that the charge, in this example embodiment, is a fee paid to the issuer 108 for the installment transaction, because the issuer 108 is the lender behind installments to be paid by the user 112. In other embodiments, the method 300 may rely on the IPP 118, whereby at 330, the processing network 106 apportions the charge between the issuer 108 and the IPP 118.

When the appropriate charge is added, and other associated fees are indicated, the processing network 106 settles the transaction (and various other transactions), whereby the acquirer 104, the issuer 108, the IPP 118 (potentially), and the processing network 106 are paid for the transaction.

In view of the above, the systems and methods herein provide for flexible implementation of installments which generally leverage existing infrastructure of the processing network. As such, there is limited processing, implementation and infrastructure impact on first parties, acquirers and issuers associated with the transactions. What's more, the installment initiation is included in the standard clearing and settlement for transactions involving the first parties, the acquirers, and the issuers.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and without limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving an authorization message for a network transaction, the authorization message including a merchant ID (MID), an interbank card association (ICA) number, and a primary account number (PAN) for an account of a user; (b) determining whether the MID and ICA are registered for installments; (c) in response to determining that the MID and ICA are registered for installments: (1) determining whether the PAN is an installment PAN; and (2) in response to determining that the PAN is the installment PAN: determining a resource code based on the authorization message; appending the resource code to the authorization message; and forwarding the authorization message including the resource code to an issuer of the account.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in managing network traffic, the method comprising:
receiving, at an installment host computing device, an authorization message for a network transaction, the authorization message including a merchant ID (MID), an interbank card association (ICA) number, and a primary account number (PAN) for an account of a user;
determining, by the installment host computing device, whether the MID and ICA are registered for installments;
in response to determining that the MID and ICA are registered for installments:
determining, by the installment host computing device, whether the PAN is an installment PAN; and
in response to determining that the PAN is the installment PAN:
determining, by the installment host computing device, a resource code based on the authorization message;
appending, by the installment host computing device, the resource code to the authorization message; and
forwarding, by the installment host computing device, the authorization message including the resource code to an issuer of the account.

2. The computer-implemented method of claim 1, wherein determining whether the MID and ICA are registered includes searching for the MID and ICA in a registered data structure.

3. The computer-implemented method of claim 1, wherein determining whether the PAN is an installment PAN includes determining whether a bank identification number (BIN) of the PAN is included in an installment BIN range of the issuer.

4. The computer-implemented method of claim 1, wherein determining the resource code based on the authorization message includes determining the resource code based on an amount for the network transaction included in the authorization message.

5. The computer-implemented method of claim 1, wherein the authorization message includes an ISO 8583 message; and
wherein appending the resource code to the authorization message includes appending the resource code to data element (DE) 48 of the authorization message.

6. The computer-implemented method of claim 1, further comprising:
receiving a clearing file for the network transaction;
identifying the resource code in the clearing file for the network transaction;
determining a charge for the network transaction being an installment transaction; and
imposing the charge on clearing of the network transaction.

7. The computer-implemented method of claim 6, wherein determining the charge for the network transaction includes:
retrieving terms associated with the resource code, the terms including a rate; and
calculating the charge based on the rate and an amount included in the clearing file for the network transaction.

8. The computer-implemented method of claim 7, wherein imposing the charge on clearing of the network transaction includes splitting the charge between the issuer and an installment payment provider.

9. A system for use in managing network traffic, the system comprising:
a host computing device including a processor and memory having executable instructions, which when executed by the processor, cause the processor to:
receive an authorization message for a network transaction, the authorization message including a merchant ID (MID), an interbank card association (ICA) number, and a primary account number (PAN) for an account of a user;
determine whether the MID and ICA are registered for installments;
in response to a determination that the MID and ICA are registered for installments:
determine whether the PAN is an installment PAN; and
in response to a determination that the PAN is the installment PAN:
determine a resource code based on the authorization message;
append the resource code to the authorization message; and
forward the authorization message including the resource code to an issuer of the account.

10. The system of claim 9, wherein the executable instructions, when executed by the processor to determine whether the MID and ICA are registered, cause the processor to search for the MID and ICA in a registered data structure.

11. The system of claim 9, wherein the executable instructions, when executed by the processor to determine whether the PAN is an installment PAN, cause the processor to determine whether a bank identification number (BIN) of the PAN is included in an installment BIN range of the issuer.

12. The system of claim 9, wherein the executable instructions, when executed by the processor to determine the resource code based on the authorization message, cause the processor to determine the resource code based on an amount for the network transaction included in the authorization message.

13. The system of claim 9, wherein the authorization message includes an ISO 8583 message; and
wherein the executable instructions, when executed by the processor to append the resource code to the authorization message, cause the processor to append the resource code to data element (DE) 48 of the authorization message.

14. The system of claim 9, wherein the executable instructions, when executed by the processor, further cause the processor to:
receive a clearing file for the network transaction;
identify the resource code in the clearing file for the network transaction;
determine a charge for the network transaction being an installment transaction; and
impose the charge on clearing of the network transaction.

15. The system of claim 9, wherein the executable instructions, when executed by the processor to determine the charge for the network transaction, cause the processor to:
retrieve terms associated with the resource code, the terms including a rate; and
calculate the charge based on the rate and an amount included in the clearing file for the network transaction.

16. The system of claim 9, wherein the executable instructions, when executed by the processor to impose the charge on clearing of the network transaction, cause the processor to split the charge between the issuer and an installment payment provider.
